(19) United States
(12) Patent Application Publication
(10) Pub. No.: US 2003/0155688 A1
(43) Pub. Date: Aug. 21, 2003

(54) Antifouling product and method of making it

(76) Inventors: Robert Oram, Loirston (GB); Kenneth Toole, Loirston (GB)

Correspondence Address: CLARK & BRODY, SUITE 600, 1750 K STREET, NW, WASHINGTON, DC, 20006, US

(21) Appl. No.: 10/321,496

(22) Filed: Dec. 18, 2002

(30) Foreign Application Priority Data
Dec. 20, 2001 (GB) 0130452.6

(51) Int. Cl. B29C 39/10

(52) U.S. Cl. 264/279; 264/275; 264/338

(57) ABSTRACT

A method of forming an antifouling article comprising the steps of

viii) providing a mould,

ix) applying a layer of film-forming adhesive to at least portions of the mould,

x) introducing granules of copper-containing material to the mould,

xi) causing the granules to adhere to the film-forming adhesive,

xii) introducing curable elastomeric material into the mould,

xiii) curing the elastomer, and

xiv) removing the antifouling article from the mould.

Articles made in accordance with the method are also disclosed.

This invention relates to an antifouling material and a method of making it.

Marine biofouling is commonplace on marine structures and equipment by way of non-limiting example including pilings, offshore platforms, boat hulls, surface/subsurface buoyancy products.

The actual nature and degree of marine fouling varies with geographic location and distance from the surface, these factors being related to subsurface light intensity and water temperature. Marine plant fouling is largely restricted to the splashzone and first 50 m subsurface, whilst “hard foul”—fouling by shellfish of various types—can occur down to 150 m, until water temperature eventually inhibits growth. “Soft foul” by species such as algae and slimes can occur down to 250 m or more, but is a very modest scale phenomenon.

For almost every service, such fouling is a severe problem, leading to excess drag on structures and marine craft, loss of uplift on buoyancy products and loss of function on specialist subsea polymer products such as bend restrictors and VIV suppression strakes. Regular removal by mechanical means is always expensive and sometimes impractical, depending upon the system construction and operating conditions.

Copper-nickel alloys and copper itself have a high natural resistance to biofouling. Copper-nickel (hereinafter “CuNi”) products are now in more extensive use than copper as antifouling cladding, due to their demonstrated reduced erosion/corrosion rate in service for equivalent antifouling performance, Commercial CuNi alloys as used in antifouling generally incorporate up to 2% iron and the expressions “CuNi” or “copper-nickel” as used herein embraces also alloys including small amounts of other materials such as iron.

For structures and equipment with rigid and semi-rigid surfaces, e.g. those constructed of metal, FRP or wood, copper-nickel antifouling is typically provided by sheathing the surface in CuNi sheet, taking due regard to the requirement for galvanic isolation from less noble materials such as steel and aluminium. For polymer products which require to flex or articulate in operation, or which are of extreme complex shapes and curvature, such cladding in rigid CuNi sheeting is obviously impractical.

To date, the only method of providing CuNi antifouling to such polymer products has been to create the CuNi antifouling coating separately, either as a synthetic rubber sheet containing CuNi granules, or as a CuNi mesh encapsulated in a polyester resin, and then to attempt to bond the CuNi “carrier coating” to the polymer product. For the synthetic rubber system, this can be very effective where the underlying polymer product is of an identical polymer and a high performance bond can be created by vulcanisation. Unfortunately, the mechanical properties and available methods of product manufacture of the limited number of grades of rubbers suitable for this bonding process severely limit their use across the range of subsea, fouling prone products. As the majority of subsea polymer products requiring antifouling protection have complex shapes only suited to moulding and casting-type nanufacture, the standard generic material for such products is polyurethane. elastomer, which cannot be vulcanised. Additionally, the vulcanisation process requires very particular geometry of the surface for effective bonding: the majority of surface features and geometries are not so-suited. For the majority of substrate identities and geometries, where vulcanisation is either not possible chemically or not practical as a process, the only alternative currently is to attempt adhesive based bonding of the pre-formed antifouling sheeting to the substrate. Unfortunately there are no adhesive systems with proven subsea performance for 10-30 years, so that adoption of the adhesively bonded system incurs a major, potentially unacceptable, risk of system failure and loss of essential antifouling protection.

U.S. Pat. No. 4,753,701 describes a method of making an anti fouling material. A flexible web having a sticky adhesive surface is drawn through a trough of CuNi granules causing some of the granules to adhere to the web. A bonding agent is then applied and the particles attached to the web abutted against an incompletely cured rubber article. The rubber article is cured and the web stripped away leaving CuNi granules exposed.

U.S. Pat. No. 4,375,199 describes an antifouling panel for application to submersible and semisubmersible structures. A glass reinforced plastics panel is prepared with a copper containing wool or meshes incorporated therein with knuckles of the copper containing material exposed. The panel is secured to the structure by cement.

GB 2 126 959 describes an antifouling material or marker comprising a neoprene base in which is dispersed copper containing antifouling matter. The antifouling material is then secured to the object.

None of the art discussed above discloses or suggests how the risk of delamination of the antifouling from the product can be achieved.

In accordance with the invention the copper containing antifouling material is formed integrally with exposed surfaces of the polymer product itself. Since the antifouling material is formed integrally with the product delamination is unlikely to occur.

Embodiments of the invention will be described by way of non-limiting example by reference to the accompanying figures of which

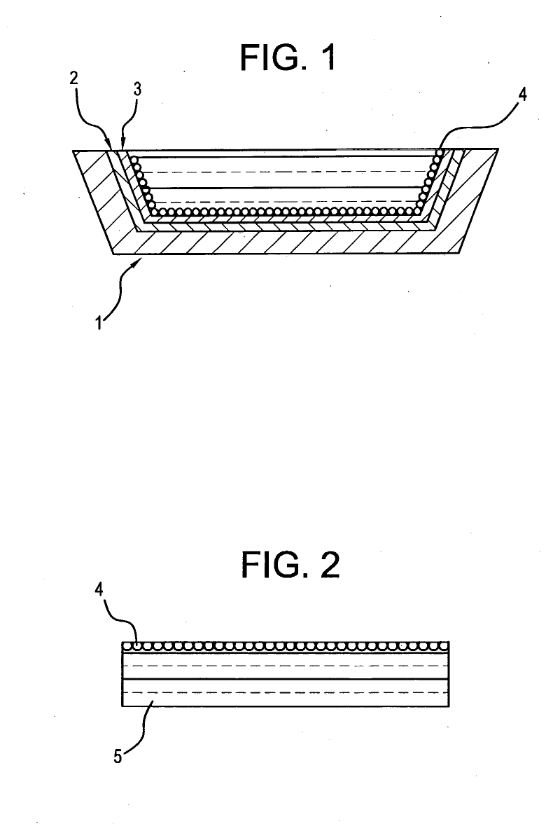

FIG. 1 is a sectional view of an article of the invention following curing but prior to removal from a mould: and

FIG. 2 is a sectional view of an article of the invention.

The invention seeks to take the current material of choice for marine antifouling, i.e. 90:10 Copper-Nickel alloy (e.g. CuNi10Fe1Mn, CW352H), and embed it in the surface of a moulded polyurethane elastomer product (whilst 90:10 CuNi alloy is the preferred material, other alloys such as 70:30 CuNi (e.g. CuNi30Fe2Mn2, CW353H or CuNi30Mn1Fe, CW354H) or pure copper may be similarly employed). To maintain flexibility, the Copper-Nickel alloy is provided in the form of granules manufactured from chopped wire, nominally 1 mm diameter and 1 mm long. Granule density is such as to achieve a weight concentration of 4.0-4.5 kg CuNi/m², surface. With this granule size and weight concentration, surface coverage is minimum 30% area as CuNi granules. This combination of weight concentration, granule size and surface coverage is accepted as giving at least 40 years antifouling protection.

As distinct from the prior proposals the invention provides an antifouling composition integrally formed with the article itself which is usually load bearing. The article is generally made from a polyurethane composition.

Mould 1 is provided and can be prepared in ways well known to the skilled worker in the art. Typical mould materials include metals such as aluminium and steel and polymer material such as fibre reinforced plastics material. A release coating 2 for example of a silicone containing material is then, generally, applied to the mould surfaces. Release coating 2 reduces the likelihood of the eventual product bonding to or binding into the mould.

A curing or drying film forming adhesive layer 3 is then applied to the release coating layer 2. The film-forming adhesive should be capable of halving sufficient tack or holding power to retain a substantial complete layer of the copper containing material to be described hereinafter. Typical wet thicknesses of the film forming adhesive layer are in the range of 0.025-0.1 mm.

Granules of copper containing material such as 1 mm lengths of 1 mm diameter CWH352H wire are introduced into the mould 1. The mould is typically closed and agitated or rotated to allow the granules to be retained by the film forming adhesive and form a copper containing layer 4.

In preferred embodiments of the invention an excess, typically a 10-30% excess over the target weight, concentration is introduced into the mould. Following agitation or rotation the mould is opened and any excess copper containing material not secured to the film forming adhesive can be discharged.

In some embodiments of the invention the adhesive is not applied to the whole of the release-coating layer. Copper containing material does not bond to this part of the release-coating layer 2. This may be adopted where not all outside faces of the eventual product are subject to fouling for example those not exposed to seawater in use.

Adhesive layer 3 is then cured or dried as appropriate to bond the copper containing material firmly.

Elastomer for example polyurethane elastomer typically a 2 part mixture comprising an isocyanate and a polyether polyol is introduced into the mould space. The elastomer material penetrates between the copper containing granules and cures to form elastomeric portion 5.

Once the elastomer is cured the mould can be opened and the article removed. The outside of the article comprises a copper containing layer overlain in part by the film forming adhesive layer and possibly some release coating layer. The outside of the article can be lightly abraded or grit blasted to remove adhesive layer and provide an effective antifouling surface integrally bonded with the polyurethane (“PU”) article.

As an alternative to removal of the adhesive layer from the polyurethane elastomer surface, the adhesive may be selected such that it will achieve a high strength bond, ideally a chemical bond, to the PU elastomer surface. With this type of system, surface abrasion need be limited only to that extent necessary to give exposure of the copper containing material such as CuNi granules effective to confer sufficient antifouling properties, rather than complete removal of adhesive. For products based on PU elastomer, single component polyurethane pre-polymer systems, such as pre-polymer R458 from Rosehill Polymers Ltd are particularly effective.

Good bond strength between the CuNi granules and the PU elastomer is achieved simply by ensuring that the granules are thoroughly cleaned, degreased and dried prior to use. Further enhancement of the bond integrity may be achieved by pre-treatment of the CuNi granules with an adhesion promoter or primer: examples include silanes and noble metal complexes, titanate and zirconates. Many conventional polymer-based adhesion promoters are similarly effective. These adhesion promoters may be applied directly to the granules or dispersed in a low boiling point solvent. Excess treatment is drained from the granules and the granules allowed to thoroughly dry before use in the process described above. Alternatively, some adhesion promoters are effective when added to the polyol component of the PU elastomer system: silane based systems are particularly effective when used in this way. One material found to give particularly good adhesion enhancement is Silane AEl from ABCR Ltd.

The standard Quality Control test that has been developed for the “Avonclad” granules—in neoprene-rubber system is to bend a 3-5 mm. thick sheet of the granule-impregnated material around a 25 mm diameter rod: the granules should be fully retained by the substrate during this test. A sheet of material of the invention is prepared by applying in turn the adhesive and then the granules to a polypropylene sheet, and then pouring a 3-5 mm thick layer of PU elastomer on to the granule-coated sheet and allowing the system to fully cure off before removal and abrasive cleanup. The sheet so prepared easily passes the “Avonclad” QC test, with complete granule retention. An additional test, more suited for semiquantitative evaluation of different adhesion promoters has been developed using a Taber Abrader. Here the abrasion wheel (number S35) is applied to a flat sheet of the antifouling system for 500 cycles. The area of granule disbondment provides a semiquantitative evaluation of adhesion promoter effectiveness relative to the “standard” system without adhesion promoter: results of granule removal area ranged between 60% and 5000% of the “standard” during testing of a range of potential adhesion promoters. Best performance was achieved with silane-based treatment AEl from ABCR, added directly to the polyol component of the PU mix, at 0.5 wt %.

The invention can be used to form a wide range of products non-limiting example include pilings, offshore platforms, boat hulls, surface/subsurface buoyancy products and other subsea polymeric materials such as bend restictors and VIV suppression strakes.

1 a method of forming an antifouling article comprising the steps of
i) providing a mould,
ii) applying a layer of film-forming adhesive to at least portions of said mould,
iii) introducing granules of copper-containing material to said mould,
iv) causing said granules to adhere to said film-forming adhesive,
v) introducing curable elastomeric material into said mould,
vi) curing said elastomeric material, and
vii) removing said antifouling article from said mould.

2 The method of claim 1 wherein a release layer coating is applied to said mould prior to application of said film forming adhesive.

3 The method of claim 1 wherein said curable elastomeric material comprises a polyurethane polymer precursor.

4 The method of claim 1 wherein the copper containing granules are treated with an adhesion promoter or primer prior to introduction of said curable elastomeric material into said mould.

5 An antifouling article comprising a core of elastomeric material bonded to copper containing granules.

6 The use of an article as claimed in claim 5 as a structural element in surface/subsurface buoyancy products.
